(19) United States
(12) Patent Application Publication
(10) Pub. No.: US 2019/0174843 A1
(43) Pub. Date: Jun. 13, 2019

(54) FASTENING SYSTEM FOR MOTORCYCLE RIDING SUIT

(71) Applicant: Gabriel da Silva Ribeiro, Sao Paulo (BR)

(72) Inventor: Gabriel da Silva Ribeiro, Sao Paulo (BR)

(21) Appl. No.: 16/324,533

(22) PCT Filed: Aug. 16, 2017
(86) PCT No.: PCT/BR2017/050229

§ 371 Date: Feb. 8, 2019

(30) Foreign Application Priority Data
Aug. 19, 2016 (BR) 10 2016 019275 7

(51) Int. Cl. A41D 3/00; A41D 1/08; E05B 67/38

(52) U.S. Cl. CPC A41D 3/00; A41D 1/08; A41D 2600/102; A41D 2300/322; A41D 2300/32; E05B 67/383

(57) ABSTRACT

Fastening system for motorcycle riding suit, comprising coupling devices built into the suit, the jacket providing a frontally closing device that includes a coupling device provided with through-holes and attached to a segment of strong fabric, while the pelvis region of the trouser is provided with an overlapping segment embedding a coupling device provided with through holes attached to a segment of strong fabric and positioned in alignment way with the coupling device of the jacket, when overlapped to the coupling device, receives a its holes a lock, chain or cable fastened by padlock.

### RELATED APPLICATION INFORMATION

This application claims priority to International PCT Application No. PCT/BR2017/050229, with an international filing date of Aug. 16, 2017, entitled “FASTENING SYSTEM FOR MOTORCYCLE RIDING SUIT,” which claims priority to Brazilian Patent Application No.: BR 10 2016 019275 7 filed Aug. 16, 2016, the disclosures and figures of which are incorporated by reference as if set forth herein in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the patent and trademark office patent files or records, but otherwise reserves all copyright and trade dress rights whatsoever.

### BACKGROUND

### Field

The present invention patent application relates to a “FASTENING SYSTEM FOR MOTORCYCLE RIDING SUIT” which has been developed for the purpose of providing a fastening system for a motorcycle driving suit which utilizes through holes to secure the suit to the vehicle.

Description of Related Art

Due to the need for protection, the use of motorcycle suits and safety equipment for motorcycle riding has become increasingly frequent, in the chaotic traffic of large cities, for use in sports trips or long journeys.

However, outside of traffic, either because it is not comfortable, or because without wind can occur excessive heating, or for any other reason, the use of such suits becomes inconvenient, and it is necessary to remove it.

Currently, there are no appropriates systems for fixing motorcycle riding suit to a vehicle, it is necessary that it be stored in compartments of the vehicle itself, in attached luggage racks or even taken with the driver.

### DESCRIPTION OF THE DRAWINGS

In order to obtain a perfect understanding of what has been developed, there are attached illustrative drawings to which reference numerals are made together with a detailed description which follows, wherein:

FIG. 1 shows a front view of the complete suit.

FIG. 2 shows a perspective view of coupling devices.

FIG. 3 shows a perspective view of the rings and cable ties.

FIG. 4 shows a perspective view of the overlap segment.

FIG. 5 shows a perspective view of the u-lock lock.

FIG. 6 shows a front view of the suit superimposed and with u-lock lock.

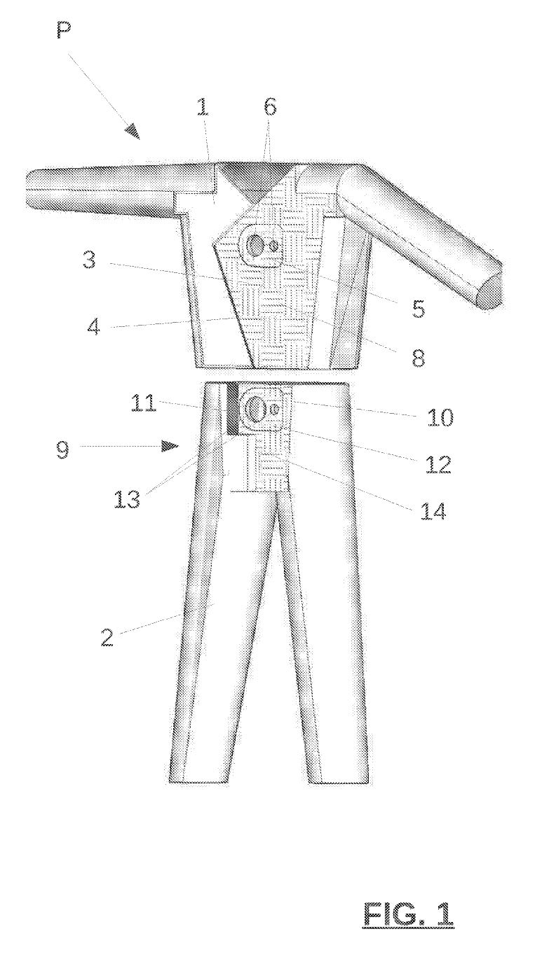

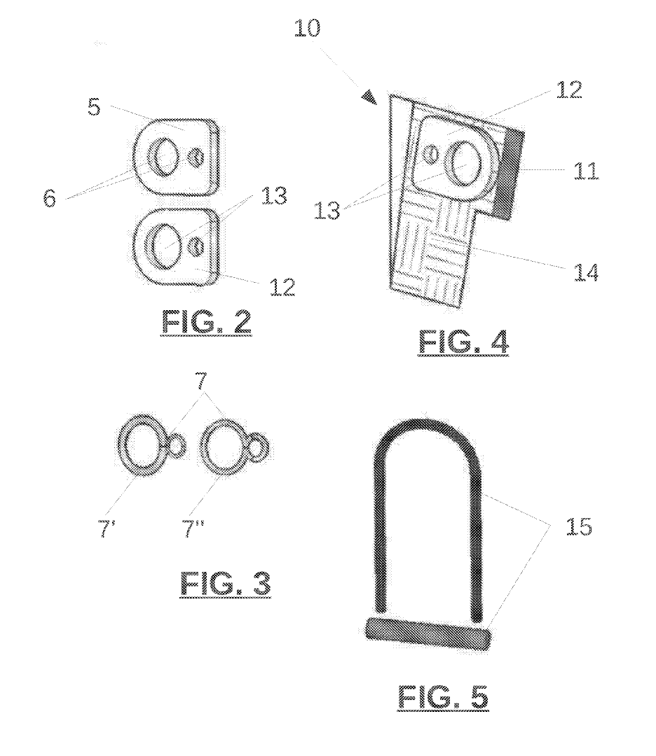

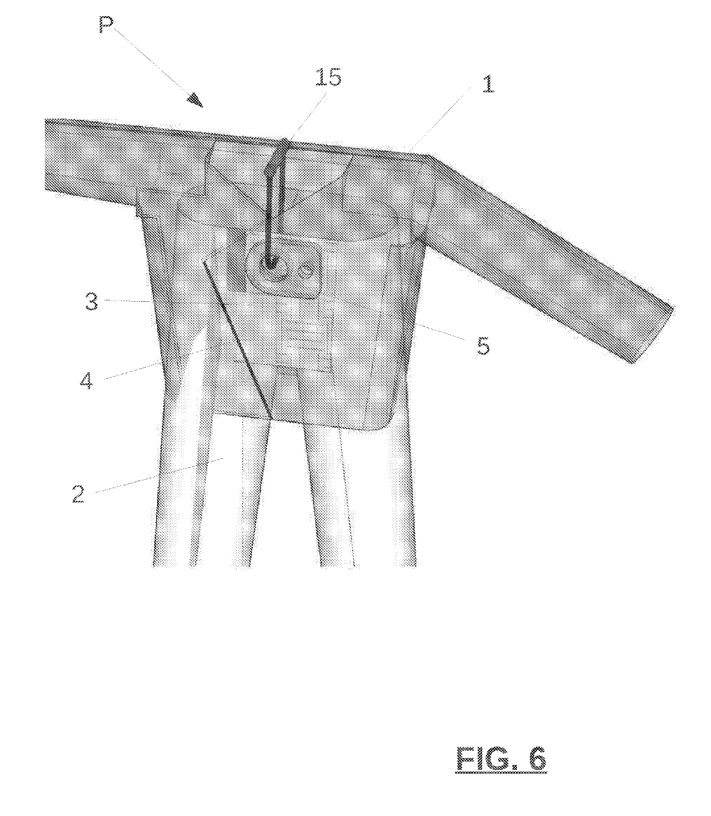

### DETAILED DESCRIPTION

In order to make it practical to fasten the motorcycle riding suit, and to maintain it safe against theft, so after a long period of tests and studies the inventor has developed the “FASTENING SYSTEM FOR MOTORCYCLE DRIVING SUIT” which allows to a suit and its respective integral parts are secured to the vehicle by means of one or more through holes present in the suit, such holes preferably being made of deformation resistant materials in order to avoid violation of the structural integrity, and enabling the use of a lock, chain or cable secured by padlock to keep the suit and its parts attached to the motorcycle.

Through holes specially designed to fasten the suit, cables, chains or a lock can be passed in order to fasten the suit to the handlebar or the luggage rack, for example. This lock can be specifically designed to fit the shape of the suit holes, offering greater resistance to theft. The position of the holes in the parts of the suit can further be arranged so that such parts can be overlapped and secured together by a single lock, which makes the fastening process quick and convenient.

As shown in the figures and in its details, the “FASTENING SYSTEM FOR MOTORCYCLE RIDING SUIT”, characterized in that the coupling devices made of tamper resistant material embedded into a suit (P) or assembly, formed by a jacket (1) and a trouser (2), the jacket being provided with a frontally transverse closure (3) provided with a zipper (4), said transverse closure (3) incorporating a coupling device (5) provided with through-holes (6) fixed to a segment (8) of resistant fabric, while the trouser (2) is provided in the pelvic region (9) of an overlap segment (10) with Velcro (11), said segment (10) incorporating a coupling device (12) provided with through holes (13) fixed to a segment (14) of resistant fabric and positioned in a manner aligned to the coupling device (5) of the jacket (1), which may be superimposed on the coupling device (12) of the trouser (2), which together or separately receive in its holes a u-lock type lock (15), wherein in a derivative arrangement the coupling devices (5) (12) are replaced by coupling rings (7), which can be formed by rings (7′) or by cable ties (7″).

Based on what was described and illustrated we can say that the “FASTENING SYSTEM FOR MOTORCYCLE RIDING SUIT”, is a product that brings huge advantages, as the use of this system becomes frequent, new designs of suits can be designed so that the placing and removal of the suit by the driver to become faster, speeding the fastening and release of the suit to the vehicle.

By being innovative and hitherto not understood in the prior art, it perfectly fits within the criteria of the invention patent application. Its claims are as follows.

1. A fastening system for a motorcycle riding suit comprising:
coupling devices made of tamper resistant material embedded into an assembly, formed by a jacket, the jacket being provided with a frontally transverse closure provided with a zipper, said transverse closure incorporating a coupling device provided with through-holes fixed to a segment of resistant fabric.

2. The suit of claim 1, the assembly further comprising a trouser, the trouser is provided in the pelvic region of an overlap segment with Velcro, said segment incorporating a coupling device provided with through holes fixed to a segment of resistant fabric.

3. The suit of claim 2, the coupling device (12) positioned in a manner aligned to the coupling device of the jacket, which may be superimposed on the coupling device of the trouser.

4. The suit of claim 3, the coupling device and the coupling device, which together or separately receive in its holes a u-lock type lock.

5. A fastening system for a motorcycle riding suit comprising coupling devices made of coupling rings, which can be formed by rings or by cable ties embedded into an assembly, formed by a jacket, the jacket being provided with a frontally transverse closure provided with a zipper, said transverse closure incorporating a coupling device provided with through-holes fixed to a segment of resistant fabric.

6. The suit of claim 5, the assembly further comprising a trouser, the trouser is provided in the pelvic region of an overlap segment with Velcro, said segment incorporating a coupling device provided with through holes fixed to a segment of resistant fabric.

7. The suit of claim 6, the coupling device positioned in a manner aligned to the coupling device of the jacket, which may be superimposed on the coupling device of the trouser.

8. The suit of claim 7, the coupling device and the coupling device, which together or separately receive in its holes a u-lock type lock.
